(19) United States
(12) Patent Application Publication
(10) Pub. No.: US 2023/0279261 A1
(43) Pub. Date: Sep. 7, 2023

(54) LOW-BLUSHING COATING FORMULATIONS AND ASSOCIATED USES

(71) Applicant: MICHELMAN, INC., Cincinnati, OH (US)

(72) Inventor: Christopher L. MOST, Edgewood, KY (US)

(73) Assignee: MICHELMAN, INC., Cincinnati, OH (US)

(21) Appl. No.: 17/904,436

(22) PCT Filed: Mar. 5, 2021
(86) PCT No.: PCT/US2021/021016

§ 371 Date: Aug. 17, 2022

Related U.S. Application Data
(60) Provisional application No. 62/994,930, filed on Mar. 26, 2020.

(51) Int. Cl. C09D 177/10; C09D 7/63; C09D 7/65; C09D 5/16

(52) U.S. Cl. CPC C09D 177/10; C09D 5/16; C09D 7/63; C09D 7/65

(57) ABSTRACT

Coating formulations capable of forming coatings exhibiting minimal or no blushing may comprise an aqueous carrier fluid, an amine-terminated polyamide, a resin, an acid catalyst, and a water-soluble fluorescent compound. The resin may comprise at least one compound selected from the group consisting of an aminoplast melamine-based resin, a benzoguanamine-based resin, a cresolformaldehyde-based resin, and any combination thereof. Such coating formulations may be curable in at least about 1 minute at 200° F. Coatings formed therefrom may comprise a crosslinked reaction product of the amine-terminated polyamide and the resin. The water-soluble fluorescent compound may be compliant with 21 CFR § 175.300 (2019), of which quinine is a representative example. Such coatings that are compliant with 21 CFR § 175.300 may be disposed upon a surface in contact with a foodstuff, such as upon at least a portion of an easy-open end of a can or similar container.

### BACKGROUND

Various industries, particularly the food and beverage industry, have been moving to safer, more environmentally friendly coatings and coating formulations in recent years. Among the coating features currently sought in the food and beverage industry and others is elimination of bis-phenol A (BPA) from coatings. Research has shown that BPA can seep into food or beverages with prolonged surface contact. Exposure to BPA is a concern because of its potential to cause development disorders in fetuses and children. Additional research has shown that BPA may play a role in children’s behavior and promote increased blood pressure. Because of these potential harmful effects, manufacturers and suppliers are seeking to replace BPA-containing coatings with less problematic coating types. Another coating feature being concurrently sought is a transition from legacy epoxy-based coating technologies employing organic solvent carriers to aqueous-based coating compositions having no or minimal amounts of volatile organic compounds (VOCs).

While a transition to aqueous-based coating formulations is highly desirable for a number of reasons, such coating formulations do not usually afford drop-in replacement capabilities for the more commonly used coating formulations employing VOCs. This particularly true for low-temperature, rapid-cure coating formulations, such as the repair coatings commonly used in the food and beverage industry for spray coating application to the exterior surface of easy-open (e.g., peelable, pop-top or pull-tab) food or beverage lids. Present repair coating technologies, whose replacement is currently being sought, are successful primarily due to their use of low-boiling VOC solvents and high- reactivity epoxy curing agents. The relatively high boiling point of water and the lower reactivity of BPA-free resins and curing agents often affords considerably poorer coating performance. The high surface tension of aqueous solvents, for instance, may lead to bead formation when a coating formulation is applied to a surface, thereby leading to inconsistencies in the thickness or coverage of a coating. Low-reactivity resin systems may also require extended curing times, which may necessitate significant changes to existing process line configurations.

Another challenge associated with using aqueous-based coating formulations is the frequent need to employ surfactants for promoting solubility of the coating components in water. The use of surfactants can lead to several difficulties, however. Ionic surfactants (i.e., cationic, anionic, or zwitterionic surfactants) can migrate to the coating surface during solvent removal taking place in conjunction with the canning process and lead to a physical distortion (opaque whitening) of the coating appearance, in a process known as “blushing.” The canning process may entail high pressure steam processing, also known as steam retorting, in which blushing may be exacerbated to varying degrees depending on the pH of the steam. Absence of blushing over a broad pH range of about 5.5 to about 11 may be desirable in many instances. Although blushing does not typically impact the integrity of a coating, it can often be visually unappealing for a consumer and make purchase of a product less likely. Non-ionic surfactants are often less susceptible toward promoting blushing, but at present there are few suitable non-ionic surfactants meeting the requirements of 21 CFR § 175.300 for use in coating a surface for contact with a foodstuff and which also afford a stable aqueous dispersion for use in coating. Thus, it can be exceptionally challenging to produce blush-free, visually appealing, and regulatory-compliant coatings using water-based coating formulations.

In the food and beverage industry, metal containers containing at least one easy-open end are desirable, since they may allow a user to access the interior of the container without using a separate opening device, such as a can opener. Easy-open ends may be obtained by reducing the thickness of the metal to a score line around the perimeter of the lid defined by the easy-open end. Since the score line is a structural weak point, it may separate when sufficient force is exerted to open the lid. Production of the score line may remove a varnish layer otherwise protecting the metal from corrosion, which may be visually unappealing to a consumer at best or, more seriously, lead to potential food spoilage and compromised consumer safety if sufficient rusting occurs. Corrosion and incomplete sealing integrity may be particularly problematic during the heat sealing treatments used to reseal a food container following application of an easy-open end thereto. Other portions of metal cans and other food and beverage containers may similarly benefit from coatings that are low blushing and afford sealing and protection against corrosion.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and the benefit of this disclosure.

FIGS. 1A and 1B show diagrams of a can having an easy-open end with a coating of the present disclosure thereon.

FIGS. 2A and 2B show illustrative photographs of coated easy-open ends in which blushing has or has not occurred, respectively.

### DETAILED DESCRIPTION

The present disclosure generally relates to coatings and coating formulations that have minimal propensity toward blushing and, more specifically, to substantially blush-free coatings and coating formulations for food and beverage containers that are compliant with 21 CFR § 175.300 (2019), particularly those that are aqueous-based, surfactant-free and/or bis-phenol A-free. Non-ionic surfactants compliant with 21 CFR § 175.300 (2019) may be suitably incorporated in some cases to limit the extent of blushing that occurs. Food and beverage containers may be coated upon an easy-open end, a non-easy-open end, exterior sidewalls of the food or beverage container, or in any other location upon the exterior of the container. Disposition of the coating formulation upon an easy-open end may afford particular advantages for those types of food and beverage containers.

As discussed above, initiatives in various industries are driving development of coatings that are free of bis-phenol A (BPA) and are deposited from coating formulations having no or minimal amounts of volatile organic compounds (VOCs). Despite intense interest in this area, aqueous-based coating formulations are not usually a drop-in replacement for coating formulations containing BPA and/or VOCs, primarily due to the lower volatility of water and the slower curing rate of non-BPA resin compounds. This situation is exacerbated even further in coatings and coating formulations intended for use in the food and beverage industry, in which requirements for surface contact with a foodstuff must also be considered (21 CFR § 175.300 (2019)). The presence of ionic surfactants can lead to blushing when curing a coating formulation though aqueous solvent removal, which may be visually unappealing for a consumer. There are limited non-ionic surfactants potentially able to alleviate blushing that are both compliant with 21 CFR § 175.300 (2019) and capable of yielding a stable aqueous dispersion, which leaves manufacturers with few options for producing visually appealing coatings that are suitable for contacting a foodstuff.

The present disclosure describes aqueous-based, optionally surfactant-free coating formulations, that afford rapid curing rates and surprisingly exhibit minimal propensity toward blushing during steam retorting over a considerable range of alkaline pH values, such as those employed during steam retorting to seal easy-open cans and similar food containers. In addition, the coating formulations described herein are substantially free of BPA and may be suitable for deposition upon a surface that may come into contact with a foodstuff. In addition to their resistance against blushing, coatings obtained according to the disclosure herein may exhibit considerable flexibility and afford clean breakage at a score line without producing defects known in the industry as “feathering” or “frilling.”

In particular examples, the coating formulations disclosed herein may be especially advantageous when deposited upon a metal substrate, such as a metal substrate defining a portion of an easy-open end of a food or beverage container. Metal food and beverage containers not having an easy-open end may be coated upon their exterior with the coating formulations as well and realize similar advantages. Various adhesion promoters may further facilitate bonding to surfaces of these types, particularly to expand the range of conditions over which a cured (crosslinked) coating formulation may remain adhered to the surface. Adhesion promoters may be particularly desirable for increasing adherence of the coating upon lanolin-treated metal substrates. In non-limiting examples, the adhesion promoter may expand the range of alkaline steam retorting conditions over which a coating may remain adhered as a repair coating along a score line of the at least one easy-open end to limit corrosion thereof. Advantageously, the coating formulations disclosed herein may be employed in processing lines for such applications with no or minimal alteration of existing operating parameters.

Further advantageously, the coatings and coating formulations disclosed herein may incorporate a water-soluble fluorescent compound therein. The water-soluble fluorescent compound may serve as an optical marker to show where a coating has been deposited, particularly to verify accuracy and completeness of the deposition of the coating formulation or to verify coating integrity following steam retorting. Desirably, the water-soluble fluorescent compound may itself be compliant with 21 CFR § 175.300 (2019), so that coating formulations incorporating the fluorescent compound remain suitable for deposition upon a surface that may potentially contact a foodstuff. Quinine, which is found in ordinary tonic water, may be a particularly suitable water-soluble fluorescent compound compliant with 21 CFR § 175.300 (2019) for use in the disclosure herein. Tonic water typically contains about 83 mg quinine per 1000 g of water and may be a suitable source of water-soluble fluorescent compound in the disclosure herein.

As such, the coatings and coating formulations disclosed herein may be formed from low-toxicity components, while still affording visually appealing, rapid-cure coatings that provide good surface adherence and are not prone toward blushing during steam retorting. Selected non-ionic surfactants, such as sorbitan monostearate, may further lessen the propensity toward blushing while still maintaining compliance with 21 CFR § 175.300 (2019). Furthermore, the aqueous-based coating formulations of the present disclosure may represent substantial drop-in replacements for legacy two-part, BPA-containing, solvent-based epoxy coatings without requiring additional equipment or expensive processing line modifications.

Provided herein are aqueous-based coating formulations and coatings prepared therefrom. The coating formulations comprise an aqueous carrier fluid, an amine-terminated polyamide, a resin, an acid catalyst, and a water-soluble fluorescent compound. The resin may comprise at least one compound selected from an aminoplast melamine-based resin, a benzoguanamine-based resin, a cresol-formaldehyde-based phenolic resin, or any combination thereof. Suitable cresol-formaldehyde-based phenolic resins may feature sufficiently low etherification to remain at least partially soluble in water and retain curing capability at low temperatures. The coating formulations may be curable in at least 1 minute at 200° F., with longer curing times up to about 15 minutes, or up to about 12 minutes, or up to about 10 minutes being especially suitable to produce a more effective coating. Other suitable coating formulations may feature curing conditions of at least about 1.5 minutes of curing at 250° F. or at least about 5 minutes of curing at 280° F. Overall, suitable coating formulations may be cured within about 1 to about 15 minutes at a temperature ranging from about 200° F. to about 425° F., particularly with curing taking place over about 3 to about 12 minutes. The coating formulations, including the water-soluble fluorescent compound therein, may be compliant with 21 CFR § 175.300 (2019).

Coatings formed from the coating formulations of the present disclosure may comprise a crosslinked reaction product of the amine-terminated polyamide and the resin in the presence of the acid catalyst. In particular, coatings formed according to the disclosure herein may comprise at least a crosslinked reaction product of the amine-terminated polyamide and an aminoplast melamine-based resin, a benzoguanamine-based resin, a cresol-formaldehyde-based resin, or any combination thereof, which may be disposed as a film on a substrate, such as a metal substrate. In particular examples, the crosslinked reaction product may be formed from an aminoplast melamine-based resin. Suitable cresol-formaldehyde-based resins may be formed via acid catalysis (novolak-type) or base catalysis (resol type). The coatings formed in accordance with the present disclosure may also comprise a water-soluble fluorescent compound, which may serve as an optical marker under suitable observation conditions to determine locations in which the coatings have been deposited and/or to verify coating integrity.

In particular configurations, the coating formulations of the present disclosure and coatings formed therefrom may be substantially free of BPA. Optionally, the coating formulations and coatings formed therefrom may be substantially surfactant free, particularly free of ionic surfactants, and/or substantially free of BPA. Preferably, the coatings and coating formulations of the present disclosure are free of both ionic surfactants and BPA. Optionally, the coating formulations may comprise a suitable non-ionic surfactant compliant with 21 CFR § 175.300 (2019) and similarly be substantially free of BPA. Absence of BPA may improve the biocompatibility of the coatings and coating formulations disclosed herein. Absence of an ionic surfactant (e.g., cationic, anionic or zwitterionic) in the coating formulations and coatings described herein may minimize or eliminate blushing when the coatings undergo heat treatment, such as alkaline steam retorting during sealing or sterilizing of a food or beverage container. As such, the coatings and coating formulations disclosed herein may maintain compliance with 21 CFR § 175.300 (2019).

Suitable aqueous carrier fluids may include, for example, water or mixtures of water and a water-miscible organic co-solvent, particularly mixtures of water and a water-miscible organic co-solvent in which water is present as a majority component by weight. Water-miscible organic co-solvents that may be present include, for example, methanol; ethanol; isopropanol; butanol; isobutanol; CELLOSOLVE® (2-ethoxyethanol), butyl CELLOSOLVE (2-butyoxyethanol), texanol (2,2,4-trimethyl-1,3-pentanediol monoisobutyrate), butylcarbitol, and other glycol ethers; acetone; tetrahydrofuran; and the like. Certain coating formulations may limit or omit a water-miscible organic co-solvent due to particular application or process needs, such as to decrease the possibility of retaining trace quantities of residual water-miscible organic solvent in a coating formed after curing the coating formulation. Advantageously, one or more coalescing solvents and/or one or more tailing solvents may be present. Coalescing solvents are believed to promote surface wetting for preventing uneven coating weights and spurious blushing across a cured film. Suitable coalescing solvents may include water-miscible organic solvents that reduce the surface tension of water in the aqueous solution and discourage beading upon the surface. Tailing solvents, in contrast, may discourage formation of a crust upon the surface of the coating, thereby encouraging surface removal of solvent and curing from the substrate surface outward. Such ‘bottom-up’ curing may discourage bubble formation in the coating and promote improved adhesion to the substrate.

Coating formulations of the present disclosure may comprise about 50 wt. % to about 90 wt. % water, or about 55 wt. % to about 80 wt. % water, or about 60 wt. % to about 70 wt. % water. Optionally, a water-miscible co-solvent may also be present. When a water-miscible organic co-solvent is present, the amount of the water-miscible organic co-solvent may range from about 1 wt. % to about 20 wt. %, or about 5 wt. % to about 20 wt. %, or about 10 wt. % to about 15 wt. %.

Amine-terminated polyamides suitable for use in the disclosure herein may include one or more reaction products obtained from a polyamine and a polycarboxylic acid, particularly a dimerized or oligomeric fatty acid. Suitable polyamines for forming an amine-terminated polyamide may include, for example, those represented by the formula H(HNR)ₙNH₂ where R is an alkylene radical having from 2 to 6 carbon atoms and n is an integer ranging from 1 to 6. Illustrative polyamines that may be suitable include, for example, diethylenetriamine, triethylenetetramine, and tetraethylenepentamine. Oligomeric fatty acids that may be used to form an amine-terminated polyamide suitable for use in the disclosure herein include those resulting from the polymerization of drying or semi-drying oils or their free acids, including esters thereof, particularly from sources rich in linoleic acid. Simple drying or semi-drying oils suitable for forming amine-terminated polyamides may include soybean, linseed, tung, perilla, cottonseed, corn, sunflower, safflower and dehydrated castor oils. Suitable fatty acids may also be obtained from tall oil, soap stock and other similar materials. Without being bound by theory or mechanism, fatty acids bearing a double bond functionality may combine by a Diels-Alder mechanism to afford one or more oligomeric fatty acids.

Amine-terminated polyamides may be obtained by condensing a polyamine and a polycarboxylic acid at elevated temperatures. A stoichiometric excess of the polyamine may be used to produce a plurality of free terminal amine groups in the amine-terminated polyamide. In this instance, a stoichiometric excess refers to the condition that the number of equivalents of amine functional groups is greater than the number of equivalents of free carboxylic acid groups. The reaction product formed after condensing the polyamine with the polycarboxylic acid may have an amine number ranging from about 50 to about 80 as determined by ASTM D2896.

Suitable amine-terminated polyamides may have at least one free amine group that is capable of reacting with an aminoplast melamine-based resin, a benzoguanamine-based resin, or a cresol-formaldehyde-based resin to form a crosslinked reaction product. Particular amine-terminated polyamides that may be suitable for use in the disclosure herein include EPIKURE® resins (Hexion), such as EPIKURE® 3115.

The amine-terminated polyamides may be present in the coating formulations disclosed herein in an amount ranging from about 5 wt. % to about 25 wt. %, or about 5 wt. % to about 15 wt. %, or about 7 wt. % to about 13 wt. %, or about 10 wt. % to about 12 wt. %, each on a solids basis. The molar ratio of amine-terminated polyamide to resin may range from about 1:1 to about 1:10, such about 1:1.5 to about 1:8, or about 1:2 to about 1:7, or about 1:3 to about 1:5. Illustrative molar ratios of amine-terminated polyamide to resin may include, for example, 1:10, 1:1.6, 1:3, 1:3.7, 1:4.8, and 1:6.6.

Suitable aminoplast melamine-based resins for use in the disclosure herein include those formed by a condensation reaction between melamine and formaldehyde. Suitable aminoplast melamine-based resins may include methylated aminoplast resins or those etherified with methanol, ethanol, propanol, isopropanol, butanol or other alcohols, or any mixture thereof. Particular aminoplast melamine-based resins that may be suitable for use in the disclosure herein include MAPRENAL® and CYMEL® resins available from Cytec Industries. CYMEL 385® may be a particularly suitable aminoplast melamine-based resin for use in the disclosure herein.

The aminoplast melamine-based resin may be present in the coating formulations disclosed herein in an amount effective to promote crosslinking of the amine-terminated polyamide. In particular examples, the aminoplast melamine-based resin may be present in the coating formulations disclosed herein in an amount ranging from about 1 wt. % to about 15 wt. %, or about 2 wt. % to about 10 wt. %, or about 3 wt. % to about 8 wt. %, or about 5 wt. % to about 8 wt. %, each on a solids basis. Higher amounts of the aminoplast melamine-based resin may also be used, such as about 15 wt. % to about 75 wt. %, or about 25 wt. % to about 75 wt. %. Benzoguanamine-based resins and cresol-formaldehyde-based resins may be utilized in similar amounts ranging from about 1 wt. % to about 15 wt. % or about 15 wt. % to about 75 wt. %.

The coating formulations disclosed herein may comprise an acid catalyst to promote crosslinking between the amine-terminated polyamide and the aminoplast melamine-based resin. Suitable acid catalysts may include Lewis or Bronsted acids, including mineral acids such as hydrochloric acid, hydrobromic acid, phosphoric acid, sulfuric acid, and any combination thereof, or organic acids, including organocarboxylic acids, organosulfonic acids, organophosphoric acids, and any combination thereof. Acid catalysts particularly suitable for use in the coating formulations of the present disclosure may comprise an organophosphoric acid. Food grade phosphoric acid may be a particularly suitable acid catalyst. Suitable amounts of the acid catalyst, particularly an organophosphoric acid or phosphoric acid catalyst, for inclusion in the coating formulations disclosed herein may include, for example, about 0.1 wt. % to about 20 wt. %, or about 0.5 wt. % to about 10 wt. %, or about 1 wt. % to about 5 wt. %, each on a solids basis.

The coatings and coating formulations of the present disclosure may include an adhesion promotor. Adhesion promoters may be used, for example, when the metal surface is coated with a lubricant (e.g., a lanolin-based lubricant) that may aid in formation of a pull-tab thereon. The adhesion promoter may be a phenol-formaldehyde-based resin, such as a cresol-formaldehyde-based resin, in particular embodiments of the present disclosure. As such, the adhesion promoter may be a primary crosslinker in the coating formulations and coatings of the present disclosure, or the adhesion promoter may be used in combination with another crosslinker, such as an aminoplast melamine-based crosslinker and/or a benzoguanamine-based crosslinker. Suitable adhesion promoters may include, for example, Allnex PHENODURE PR 612, Allnex PHENODURE PR 517, Allnex PHENODURE PR 520 and similar cresol-formaldehyde-based resins, which differ in their molecular weights, ratios of o-, m- and p-substitution, and degree of etherification. As such, an adhesion promoter may impact the cure efficiency and crosslink density to adjust hardness and adhesion of the coatings formed according to the disclosure herein.

When present, suitable amounts of adhesion promoter for inclusion in the coating formulations disclosed herein may include, for example, about 5 wt. % to about 15 wt. %, or about 15 wt. % to about 50 wt. %, or about 20 wt. % to about 50 wt. %, or about 50 wt. % to about 100 wt. %, or about 50 wt. % to about 70 wt. %, or about 70 wt. % to about 100 wt. %, each on a solids basis.

Coatings and coating formulations of the present disclosure may include further additives to facilitate use thereof. Rheology control agents such as cellulose or cellulose derivatives, or non-ionic surfactants may be used. Additional polymers, such as a polyurethane dispersion, may be combined with the coatings and coating formulations. Non-ionic surfactants may also be present. Sorbitan monostearate may be a particularly suitable non-ionic surfactant for use in the disclosure herein. SURFYNOL 104PA, a non-ionic tetramethyldecyndiol surfactant, may also be suitable for use in the disclosure herein.

Any water-soluble fluorescent compound may be suitably used in the disclosure herein, provided that the fluorescence is not quenched by other components in the coating formulation. Particular examples of suitable water-soluble fluorescent compounds include those that are compliant with 21 CFR § 175.300 (2019), such that they may be deposited upon a surface in direct contact with a foodstuff. A specific example of a suitable water-soluble fluorescent compound compliant with 21 CFR § 175.300 (2019) is quinine, which is compliant in the levels found in tonic water (not exceeding 83 ppm). Although not necessarily compliant with 21 CFR § 175.300 (2019), other examples of water-soluble fluorescent compounds that may be present in the coatings and coating formulations disclosed herein include, for example, fluoresceins, rhodamines, cyanines, coumarins, oxazines, acridines, the like, and any combination or derivative thereof.

Suitable amounts of the water-soluble fluorescent compound for inclusion in the coating formulations disclosed herein may include, for example, about 0.000001 wt. % to about 0.001 wt. %, or about 0.0001 wt. % to about 0.001 wt. %, each on a solids basis.

Coatings and coating formulations of the present disclosure may be particularly resistant to blushing when exposed to conditions commonly employed during canning processes in the food and beverage industry, such as to seal a can having at least one easy-open end or other types of metal cans. In particular, coatings of the present disclosure may not undergo substantial blushing when exposed to an environment having a pH of about 9 to about 11 or about 6 to about 11 for up to about ninety minutes at a temperature of 200° F.-250° F. or 250° F.-265° F. and at a pressure of about 16 psi to about 22 psi.

Accordingly, the present disclosure also provides food or beverage containers comprising at least one easy-open end, and a coating disposed as a film on at least a portion of the at least one easy open end. Food or beverage containers lacking an easy-open end may similarly be coated in at least one location upon their exterior using the coating formulations disclosed herein. The coating comprises a crosslinked reaction product of an amine-terminated polyamide and a resin, such as an aminoplast melamine-based resin, a benzoguanamine-based resin, a cresol-formaldehyde-based rein, or any combination thereof, and a water-soluble fluorescent compound that complies with 21 CFR § 175.300 (2019). Particular coatings may feature those that are substantially surfactant free and/or substantially free of bis-phenol A. Some coatings of the present disclosure may suitably comprise a non-ionic surfactant, particularly a non-ionic surfactant compliant with 21 CFR § 175.300 (2019).

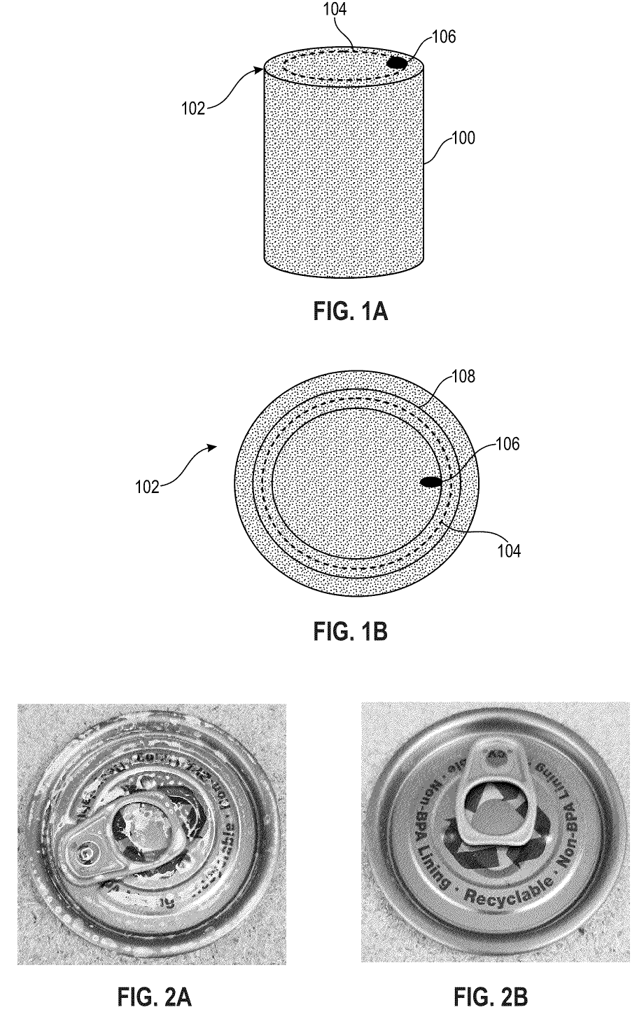

FIG. 1A shows a perspective view diagram of a can having an easy-open end with a coating of the present disclosure disposed thereon. As shown, can 100 includes easy-open end 102, which may include seam 104 and optional pull-tab 106. A coating of the present disclosure may disposed upon at least seam 104. FIG. 1B shows an end view of can 100, in which coating 108 is disposed upon seam 104. Alternately, coating 108 may be disposed upon the entirety of easy-open end 102, not just upon seam 104. Other locations upon the exterior of a can, including the ends and/or sidewalls of both easy-open and non-easy-open cans, may be coated similarly.

FIGS. 2A and 2B show photographs of an easy-open end having a polymer coating thereon, in which blushing has occurred (FIG. 2A) versus where it has not (FIG. 2B).

Embodiments disclosed herein include:

A. Low-blush coatings. The coatings comprise: a crosslinked reaction product of an amine-terminated polyamide and a resin, the crosslinked reaction product being disposed as a film on a substrate; wherein the resin comprises at least one compound selected from the group consisting of an aminoplast melamine-based resin, a benzoguanamine-based resin, a cresol-formaldehyde-based resin, and any combination thereof; and a water-soluble fluorescent compound. Optionally, the substrate is metal.

B. Coating formulations. The coating formulations comprise: an aqueous carrier fluid; an amine-terminated polyamide; a resin; wherein the resin comprises at least one compound selected from the group consisting of an aminoplast melamine-based resin, a benzoguanamine-based resin, a cresol-formaldehyde-based resin, and any combination thereof; an acid catalyst; and a water-soluble fluorescent compound; wherein the coating formulation is curable in at least about 1 minute at 200° F.

C. Food or beverage containers. The food or beverage containers comprise: at least one easy-open end; and a coating disposed as a film on at least a portion of the at least one easy-open end, the coating comprising: a crosslinked reaction product of an amine-terminated polyamide and a resin; wherein the resin comprises at least one compound selected from the group consisting of an aminoplast melamine-based resin, a benzoguanamine-based resin, a cresol-formaldehyde-based resin, and any combination thereof; and a water-soluble fluorescent compound that complies with 21 CFR § 175.300 (2019).

C1. Food or beverage containers. The food or beverage containers comprise: a coating disposed as a film on at least a portion of an exterior portion of a container body, the coating comprising: a crosslinked reaction product of an amine-terminated polyamide and a resin; wherein the resin comprises at least one compound selected from the group consisting of an aminoplast melamine-based resin, a benzoguanamine-based resin, a cresol-formaldehyde-based resin, and any combination thereof; and a water-soluble fluorescent compound that complies with 21 CFR § 175.300 (2019).

Each of embodiments A-C or C1 may have one or more of the following additional elements in any combination:

Element 1: wherein the water-soluble fluorescent compound complies with 21 CFR § 175.300 (2019).

Element 2: wherein the water-soluble fluorescent compound comprises quinine.

Element 3: wherein the coating comprises an adhesion promoter.

Element 4: wherein the adhesion promoter comprises a cresol-formaldehyde-based resin.

Element 5: wherein the resin comprises an aminoplast melamine-based resin.

Element 6: wherein the coating is substantially surfactant free and/or substantially free of bis-phenol A.

Element 7: wherein the coating does not undergo substantial blushing when exposed to an environment having a pH of about 6 to about 11 for up to ninety minutes at a temperature of 250° F.-265° F. and at a pressure of about 16 psi to 22 psi.

Element 8: wherein the coating further comprises a non-ionic surfactant.

Element 9: wherein the non-ionic surfactant comprises sorbitan monostearate.

Element 10: wherein the coating formulation is substantially surfactant-free and/or substantially free of bisphenol A.

Element 11: wherein the coating formulation further comprises an adhesion promoter.

Element 12: wherein the acid catalyst comprises an organophosphoric acid or phosphoric acid.

Element 13: wherein the coating formulation further comprises a non-ionic surfactant.

Element 14: wherein the coating is disposed upon at least a seam of the at least one easy-open end.

By way of non-limiting example, exemplary combinations applicable to A include, but are not limited to, 1 or 2, and 3; 1 or 2, and 3 and 4; 1 or 2, and 5; 1 or 2, and 5 and 6; 1 or 2, and 5 and 7; 1 or 2, and 5-7; 1 or 2, and 5-8; 1 or 2, and 3 and 6; 1 or 2, and 3 and 7; 1 or 2, and 3, 6 and 7; 1 or 2, and 8; 1 or 2, and 3 and 8; 1 or 2, and 3, 6 and 8; 1 or 2, and 3, 6, 7 and 8; 1 or 2, and 8 and 9; 3 or 4, and 5; 3 or 4, and 6; 3 or 4, and 5 and 6; 3 or 4, and 5-7; 3 or 4, and 5 and 7; 3 or 4, and 5-8; 5 and 6; 5 and 7; 5 and 8; 5-7; 5-8; 6 and 7; and 6 and 8. Further non-limiting exemplary combinations applicable to B include, but are not limited to, 1 or 2, and 11; 1 or 2, and 4 and 11; 1 or 2, and 12; 1 or 2, and 4 and 12; 1 or 2, and 4, 11 and 12; 1 or 2, and 10; 1 or 2, and 10 and 11; 1 or 2, and 4, 10 and 11; 1 or 2, and 4 and 10-12; 4 or 11, and 10; 4 or 11, and 12; 4 or 11, and 10 and 12; 4 or 11, and 5; 4 or 11, and 5 and 10; 4 or 11, and 5 and 12; 4 or 11, and 5, 10 and 12; 4 or 11, and 10 and 13; 4 or 11, and 12 and 13; 4 or 11, and 5 and 13; 4 or 11, and 5, 10 and 13; 4 or 11, and 5, 12 and 13; 4 or 11, and 5, 10, 12 and 13; 5 and 10; 5 and 11; 5 and 12; 5 and 13; 10 and 11; 10 and 12; 10 and 13; 9-11; 9-12; 9, 10 and 12; 9, 10 and 13; 11 and 12; 11 and 13; and 12 and 13. Further non-limiting exemplary combinations applicable to C or C1 include, but are not limited to, any of the exemplary combinations applicable to A, optionally in further combination with 14.

To facilitate a better understanding of the disclosure herein, the following examples of various representative embodiments are given. In no way should the following examples be read to limit, or to define, the scope of the present disclosure.

### EXAMPLES

Example 1: Intermediate Solutions 1, 2, and 3 (compositions shown in Table 1 below) were prepared and initially kept separate from one another. Intermediate Solutions 1, 2, and 3 were prepared by blending the individual components in Table 1 in the listed order under medium shear at ambient temperature using a Cowles mixer unless otherwise noted.

TABLE 1

| Intermediate Solutions | Composition |
|---|---|
| Intermediate Solution 1 | 1) 80 g EPIKURE® 3115 (warmed to 70° C.) |
| | 2) 20 g isobutanol |
| Intermediate Solution 2 | 1) 47.95 g deionized H₂O |
| | 2) 13.16 g CYCAT® 296-9 |
| | 3) 38.89 g Intermediate Solution 1 (warmed to 70° C.) |
| Intermediate Solution 3 | 1) 1000 g deionized H₂O |
| | 2) 0.083 g quinine |

EPIKURE® 3115 is an amine-terminated polyamide available from Hexion. This product has an amine value of 230-246 mg/g (as determined by ASTM D2896), a viscosity at 40° C. of 500-750 P (as determined by ASTM D2196), and a color of 9 Gardner (as determined by ASTM D1544). CYCAT® 296-9 is an organophosphoric acid catalyst available from Allnex.

Next, Coating Formulations 1A and 1B were prepared by combining Intermediate Solutions 1, 2, and 3 with CYMEL 385 aminoplast resin (Hexion), a methylated high imino melamine-based resin, as set forth in Table 2 below. The individual components in Coating Formulations 1A and 1B were combined in the order listed and blended under medium shear at ambient temperature using a Cowles mixer unless otherwise noted. All weight percentages are on a resin solids basis.

Coating Formulations 1C, 1D and 1E were prepared similarly. PHENODUR® PR-517 is a phenolic resin (Allnex). SURFYNOL 104PA is a non-ionic tetramethyldecyndiol surfactant (Evonik). NEORES R-1005 is an APEO-free polyurethane dispersion (DSM).

TABLE 2

| | |
|---|---|
| Coating Formulation | Composition |
| 1A | 1) 39.22 g Intermediate Solution 2 |
| | 2) 5.19 g CYMEL® 385 |
| | 3) 10.00 g isobutanol |
| | 4) 40.59 g deionized H₂O |
| | 5) 5.00 g Intermediate Solution 3 |
| | Final composition: |
| | -64.5 wt. % EPIKURE® 3115 |
| | -13.6 wt. % CYCAT® 296-9 |
| | -21.9 wt. % CYMEL® 385 |
| 1B | 1) 34.31 g Intermediate Solution 2 |
| | 2) 7.79 g CYMEL® 385 |
| | 3) 10.00 g isobutanol |
| | 4) 42.89 g deionized H₂O |
| | 5) 5.00 g Intermediate Solution 3 |
| | Final composition: |
| | -55.7 wt. % EPIKURE® 3115 |
| | -11.75 wt. % CYCAT® 296-9 |
| | -32.53 wt. % CYMEL® 385 |
| 1C | 1) 18.44 g PHENODUR® PR-517 |
| | 2) 2.60 g Intermediate Solution 1 |
| | 3) 5.33 g Sorbitan Monostearate surfactant |
| | 4) 62.37 g deionized H₂O |
| | 5) 4.42 g Intermediate Solution 3 |
| | 6) 0.52 g SURFYNOL 104PA |
| | 7) 0.08 g 70% Phosphoric Acid |
| | 8) 6.24 g NEORES R-1005 |
| | Final composition: |
| | -53.74 wt. % PHENODUR® PR-517 |
| | -10.09 wt. % EPIKURE® 3115 |
| | -25.90 wt. % Sorbitan Monostearate |
| | -0.27 wt. % 70% Phosphoric Acid |
| | -10.00 wt. % NEORES R-1005 |
| 1D | 1) 20.12 g PHENODUR® PR-612 |
| | 2) 2.60 g Intermediate Solution 1 |
| | 3) 5.33 g Sorbitan Monostearate |
| | 4) 63.80 g deionized H₂O |
| | 5) 4.42 g Intermediate Solution 3 |
| | 6) 0.52 g SURFYNOL® 104PA |
| | 7) 0.09 g 70% Phosphoric Acid |
| | 8) 3.12 g NEORES® R-1005 |
| | Final composition: |
| | -58.70 wt. % PHENODUR® PR-612 |
| | -10.09 wt. % EPIKURE® 3115 |
| | -25.91 wt. % Sorbitan monostearate |
| | -0.30 wt. % 70% Phosphoric Acid |
| | -5.00 wt. % NEORES R-1005 |
| 1E | 1) 21.3 g CYMEL® 385 |
| | 2) 13.08 g Intermediate Solution 2 |
| | 3) 58.32 g deionized H₂O |
| | 4) 7.30 g Intermediate Solution 3 |
| | Final composition: |
| | -18.53 wt. % EPIKURE® 3115 |
| | -3.91 wt. % CYCAT® 296-9 |
| | -77.56 wt. % CYMEL® 385 |

Samples of Coating Formulation 1A were deposited upon the outer perimeter of an easy-open lid (over the score line) using #0 or #10 RDS draw down rods to produce coatings of varying thicknesses. This sample weight corresponded to a coating weight of ~30 mg/4 in². The coated easy-open lid was then immediately passed into a 200° F. -250° F. hot air oven for 1 minute. Both plasma-treated and plasma-untreated lid surfaces were tested. The coated easy-open lid was then viewed under a black light to verify the coating distribution. Testing results are summarized in Table 3.

TABLE 3

| Entry | Coating Weight (mg) | Temperature (°F) | Plasma Treated? | Results |
|---|---|---|---|---|
| 1 | ~10-12 | 200-210 | No | Some blistering |
| 2 | ~10-12 | 200-210 | Yes | Some blistering |
| 3 | ~20 | 200-210 | No | Few to no blisters |
| 4 | ~6-7 | 250 | No | Some blistering |
| 5 | ~6-7 | 250 | Yes | Some blistering |
| 6 | ~17 | 250 | No | Some blistering |

The coated easy-open lids were packaged in vertical sleeves and shipped to canned food brand owners for sealing onto filled food cans. The coated easy-open lids were seamed onto filled food cans and then passed into a high pressure steam retort (250° F.-265° F.) for 30-90 minutes and at a pH range ranging from about 7 to about 11. In locations where the coating remained, there was no blushing or corrosion of the score line observed. Adhesion not efficient at a pH value of 9.0, but at pH values of 10.0, 10.5 and 11.0 the adhesion was acceptable. No appreciable blushing was observed. Rust formed in the score lines in the locations where the coating was removed during processing. Otherwise, rust formation was not problematic.

Formulations 1C, 1D and 1E were processed similarly and tested. Testing results are summarized in Tables 4-6 below, respectively. Ratings in Tables 4-6 range from 0 to 5, with 0 representing a failed test and 5 representing a test with a substantially perfect outcome. As shown, very good coating performance was realized for Formulations 3 and 4 containing a phenolic resin as an adhesion promoter. Excessive blushing occurred with Formulation 1E, possibly due to the high amounts of CYMEL 385 in this sample.

TABLE 4

Coating Formulation 1C

| Test | Results | Rating (0-5) |
|---|---|---|
| Film formation | Even hard film, no de-wetting | 4 |
| Appearance | Clear, colorless dried film | 4 |
| Adhesion | No adhesion loss on cross-hatch, tape | 5 |
| Steam Process (90′ @ 250° F., 16 psi) | Little to no blush | 4 |

TABLE 5

Coating Formulation 1D

| Test | Results | Rating (0-5) |
|---|---|---|
| Film formation | Even hard film, no de-wetting | 4 |
| Appearance | Clear, colorless dried film | 4 |
| Adhesion | No adhesion loss on cross-hatch, tape | 5 |
| Steam Process (90′ @ 250° F., 16 psi) | Slight blush in heavy coat weight areas only | 3 |

TABLE 6

Coating Formulation 1E

| Test | Results | Rating (0-5) |
|---|---|---|
| Film formation | Even film, no de-wetting | 3 |
| Appearance | Clear, slightly hazy dried film | 2 |
| Adhesion | Some pick off on x-hatch, tape | 2 |
| Steam Process (90′ @ 250° F., 16 psi) | Blushing, stronger in heavy coat weight areas | 0 |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer’s goals, such as compliance with system-related, business-related, government-related and other constraints, which vary by implementation and from time to time. While a developer’s efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. A coating comprising:
a crosslinked reaction product of an amine-terminated polyamide and a resin, the crosslinked reaction product being disposed as a film on a substrate;
wherein the resin comprises at least one compound selected from the group consisting of an aminoplast melamine-based resin, a benzoguanamine-based resin, a cresol-formaldehyde-based resin, and any combination thereof; and
a water-soluble fluorescent compound.

2. The coating of claim 1, wherein the water-soluble fluorescent compound complies with 21 CFR § 175.300 (2019).

3. The coating of claim 1, wherein the water-soluble fluorescent compound comprises quinine.

4. The coating of claim 1, further comprising:
an adhesion promoter.

5. The coating of claim 4, wherein the adhesion promoter comprises a cresol-formaldehyde-based resin.

6. The coating of claim 1, wherein the resin comprises an aminoplast melamine-based resin.

7. (canceled)

8. (canceled)

9. The coating of claim 1, further comprising:
a non-ionic surfactant.

10. (canceled)

11. The coating of claim 1, wherein the substrate is metal.

12. A coating formulation comprising:
an aqueous carrier fluid;
an amine-terminated polyamide;
a resin;
wherein the resin comprises at least one compound selected from the group consisting of an aminoplast melamine-based resin, a benzoguanamine-based resin, a cresol-formaldehyde-based resin, and any combination thereof;
an acid catalyst; and
a water-soluble fluorescent compound;
wherein the coating formulation is curable in at least about 1 minute at 200° F.

13. The coating formulation of claim 12, wherein the water-soluble fluorescent compound complies with 21 CFR § 175.300 (2019).

14. The coating formulation of claim 12, wherein the water-soluble fluorescent compound comprises quinine.

15. (canceled)

16. The coating formulation of claim 12, further comprising:
an adhesion promoter.

17. The coating formulation of claim 16, wherein the adhesion promoter comprises a cresol-formaldehyde-based resin.

18. The coating formulation of claim 12, wherein the acid catalyst comprises an organophosphoric acid or phosphoric acid.

19. The coating formulation of claim 12, wherein the resin comprises an aminoplast melamine-based resin.

20. The coating formulation of claim 12, further comprising:
a non-ionic surfactant.

21. (canceled)

22. A food or beverage container comprising:
at least one easy-open end; and
a coating disposed as a film on at least a portion of the at least one easy-open end, the coating comprising:
a crosslinked reaction product of an amine-terminated polyamide and a resin;
wherein the resin comprises at least one compound selected from the group consisting of an aminoplast melamine-based resin, a benzoguanamine-based resin, a cresol-formaldehyde-based resin, and any combination thereof; and
a water-soluble fluorescent compound that complies with 21 CFR § 175.300 (2019).

23. The food or beverage container of claim 22, wherein the water-soluble fluorescent compound comprises quinine.

24. The food or beverage container of claim 22, wherein the coating is substantially free of ionic surfactants and/or substantially free of bis-phenol A.

25. The food or beverage container of claim 24, wherein the coating does not undergo substantial blushing when exposed to an environment having a pH of about 6 to about 11 for up to ninety minutes at a temperature of 250° F.-265° F. and at a pressure of about 16 psi to about 22 psi.

26. The food or beverage container of claim 22, wherein the coating is disposed upon at least a seam of the at least one easy-open end.

27. The food or beverage container of claim 22, wherein the coating further comprises a non-ionic surfactant.

28. (canceled)
